(19) United States
(12) Patent Application Publication
(10) Pub. No.: US 2006/0209026 A1
(43) Pub. Date: Sep. 21, 2006

(54) Computer mouse cover

(76) Inventor: Philip Martin Balmes, Buckhead, GA (US)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 11/374,739

(22) Filed: Mar. 14, 2006

Related U.S. Application Data
(60) Provisional application No. 60/660,835, filed on Mar. 14, 2005.

(51) Int. Cl. G09G 5/08

(52) U.S. Cl. 345/163

(57) ABSTRACT

A cover (20) for a computer mouse (1) having a first section (24A) for covering a first mouse button (12A), a second section (24B) for covering a second mouse button (12B), and a third section (23) for covering the main body (11). The cover may be made from natural or synthetic fabric or material, animal skins, furs or hides, may be woven or non-woven, may be smooth, furry, rough, textured, stippled, may be made in any desired color, colors, pattern or patterns, pictures, photographs, and logos. An adhesive (31) secures the cover to the mouse and the cover may be treated with an antibacterial or other agent to retard the growth of undesired organisms.

### STATEMENT OF RELATED APPLICATIONS

This patent application claims the priority of U.S. Provisional Patent Application Ser. No. 60/660,835 filed Mar. 14, 2005, entitled “Computer Mouse Cover”.

### BACKGROUND OF THE INVENTION

1. Field of the Invention

The present invention relates to a cover for a computer mouse.

2. Related Art

The typical computer mouse is, in a word, boring. They generally come in only two colors: unattractive plain black and easy-to-see-dirt-on beige/off-white. Recently, a silver color has been added, but this third color does little to differentiate one person's mouse from another's. Also, by their functional nature and purpose, mouse designs are almost identical: sort of oval-shaped, with one flatter end, and a hump in the middle.

Mouses located in homes and produced for the home market are no different than mouses produced for the office or industrial markets. One typically can expect to find the black, black and silver, and beige/off-white as the common or only choice for a mouse. There exists a cottage industry for producing customized mouses, but these mouses often are of the very expensive variety, adorned with precious metals and jewels. Further, many families share a single computer, and thus, share a single mouse. Unless the family keeps a supply of disinfectant or anti-bacterial wipes next to or near the computer, germs may pass from one family member to another just by using the mouse. In may cases, this is not a problem, but if one family member happens to be ill, the illness can circulate throughout the household. Even in households with more than one computer, each family member having a computer may wish to customize their own computer, and customizing the mouse is a simple and inexpensive way of doing so.

Mouses located in offices and produced for the office market also are no different than mouses produced for the home or industrial markets. Again, one typically can expect to find the black, black and silver, and beige/off-white as the common or only choice for a mouse. Although in the office setting, most workers do have their own computer, and therefore, their own mouse, each worker also may wish to customize their own computer, and again customizing the mouse is a simple and inexpensive way of doing so.

Mouses located in public areas, such as libraries and informational kiosk stands, are used by a variety of different people, thereby providing an easy way to transmit organisms from one person to another. Therefore, it is recommended that such public computer stations, including especially the mouse, be disinfected on a fairly regular basis, preferably between users. This, of course, can be a daunting and expensive task, especially in high traffic areas low profit such as public libraries. Further, by customizing the mouse, it may be easier to determine where a certain mouse belongs, should the mouse inadvertently or wrongly be moved from one computer to another.

In addition to the above, the smooth plastic surface of the typical computer mouse can become slippery and difficult to control when the user has a sweaty palm and/or fingers. This commonly occurs when using a computer while nervous, playing exciting interactive games, for extended periods, in hotter climates, or when just when the user is hot or hot natured. Further, some users tend to have sweaty hands at almost all times. As the typical computer mouse is made of plastic which does not accommodate moisture, the computer mouse often quickly becomes moist and uncomfortable or difficult to handle under a sweaty hand. Additionally, as sweat dries, it often leaves an oily residue. This may frustrate the user, or increase the frustration of the user, thereby causing the user's hands to become even sweatier, and so on.

Therefore, a device for customizing a computer mouse and/or for addressing the above problems would be beneficial to users. Accordingly, there is a need for a device that allows for the customization of a computer mouse both for aesthetics and for identification. There is also a need for such a device for decreasing the health risks associated with multiple persons using the same computer mouse. There is a further need for such a device increasing the tactile feel of a computer mouse both for comfort and for improved operation. It is to these needs and others that the present invention is directed.

### BRIEF SUMMARY OF INVENTION

The present invention provides a cover for a computer mouse. The cover comprises a first section for substantially covering a first computer mouse button, a second section for substantially covering a second computer mouse button, and a third section for substantially covering the main body of the computer mouse. The sections can be structured from the same single component, can be structured from a plurality of components, and/or can be separate from each other. In its most basic form, the present invention preferably comprises sections that allow, or at least do not interfere with, the operation of the various components of a computer mouse, namely, the mouse buttons and the scroll wheel/button, if present.

One embodiment of the invention is a mouse cover that can be conveniently removed and replaced thereby reducing the spread of germs between the users of a common-use computer mouse. For example, the mouse cover can be structured so as to fit snugly over the mouse. For another example, the mouse cover can be structured so as to have a form fit over the mouse. For still another example, the mouse cover can have an adhesive backing that allows the mouse cover to adhere to the mouse. Other manners and means for maintaining the mouse cover on the mouse also are contemplated by and suitable for the invention.

One embodiment of the invention is a mouse cover that can provide for comfortable handling and use of the computer mouse. For example, the mouse cover can be structured out of comfortable materials or materials that have a pleasant or pleasing feel to the user. For another example, the mouse cover can be structured in shapes and configurations that are comfortable for the user. For still another example, the mouse cover can be structured of materials that enhance the tactile feel of the mouse, thus increasing improving operation.

One embodiment of the invention is a mouse cover that can enhance the aesthetics and identification of the mouse. For example, the mouse cover can be changed by the user at the will and whim of the user to be of a different design or color. For another example, the various materials of construction of the mouse cover can improve the look and other aesthetics of the mouse. For still another example, different mouses can be provided with different mouse covers to provide a quick and easy manner for identifying the owner of the mouse or to which computer the mouse belongs.

One embodiment of the invention is a mouse cover that can absorb the excess moisture from the hand of the user. For example, the mouse cover can be constructed of moisture absorbing materials such as terry cloth, wool or cotton. For another example, the mouse cover can be constructed of moisture wicking materials. For still another example, the mouse cover can include moisture controlling materials, such as talc or antiperspirants.

One embodiment of the invention is a mouse cover that does not interfere with normal use and operation of the computer mouse. For example, the mouse cover can be constructed of thin materials that do not disadvantageously increase the size of the mouse. For another example, the mouse cover components can be structured to fit exactly or nearly exactly on the various mouse components. For still another example, the mouse cover can be constructed of a single piece of material to prevent the various elements of the mouse cover from adversely interfering with each other during operation of the mouse.

Embodiments of the invention can be inexpensive and/or disposable. Embodiments of the invention can be simple to manufacture and/or easy to use. Alternative embodiments of the invention can be made of expensive and/or rare materials.

These and other features of the present invention may be used independently with one, more, or all of the other features. Other features and advantages of the present invention will become apparent upon reading the following description of the preferred embodiments, when taken in conjunction with the appended drawings, in which like reference numerals designate like parts throughout the several view, and the claims.

### BRIEF DESCRIPTION OF THE DRAWINGS

FIG. 1 is a view of a typical computer mouse.

FIG. 2A is an illustration of exemplary components of a first exemplary embodiment of the present invention.

FIG. 2B is an illustration of exemplary components of a second exemplary embodiment of the present invention.

FIG. 2C is an illustration of exemplary components of a third exemplary embodiment of the present invention.

FIG. 2D is an illustration of exemplary components of a fourth exemplary embodiment of the present invention.

FIG. 3A is an illustration of an exemplary embodiment of the present invention as shown in FIG. 2A in an exemplary environment.

FIG. 3B is an illustration of an alternative exemplary embodiment of the present invention in an exemplary environment.

FIG. 3C is an illustration of an exemplary embodiment of the present invention as shown in FIG. 2B in an exemplary environment.

FIG. 4A is an illustration of an exemplary adhesive device for attaching the present invention to a mouse.

FIG. 4B is an illustration of an alternative exemplary adhesive device for attaching the present invention to a mouse.

### DETAILED DESCRIPTION OF THE INVENTION

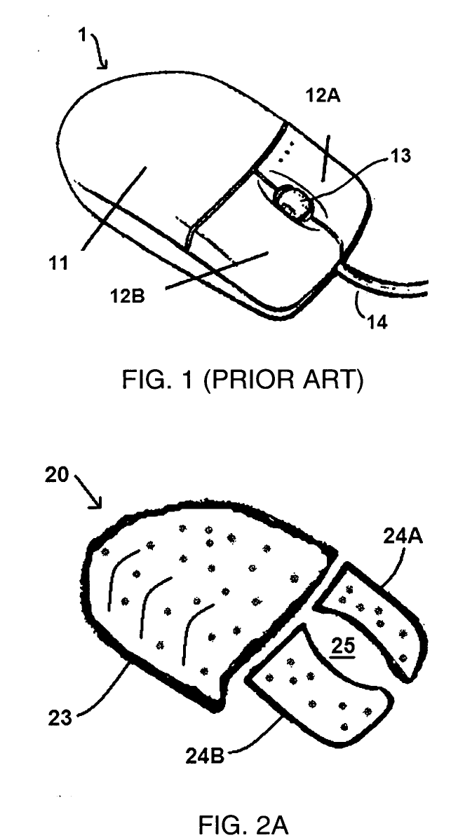

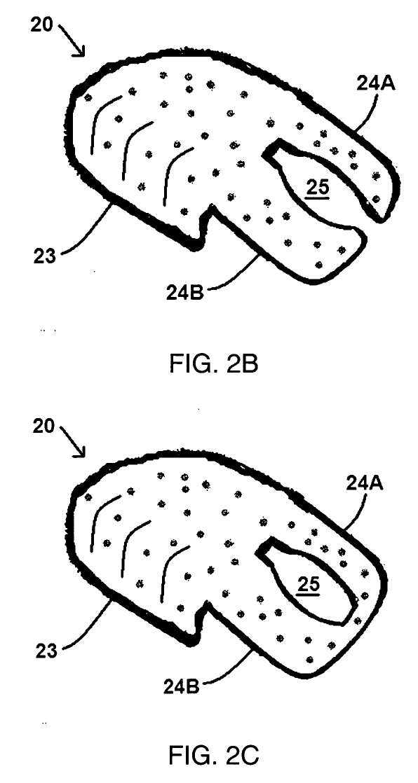

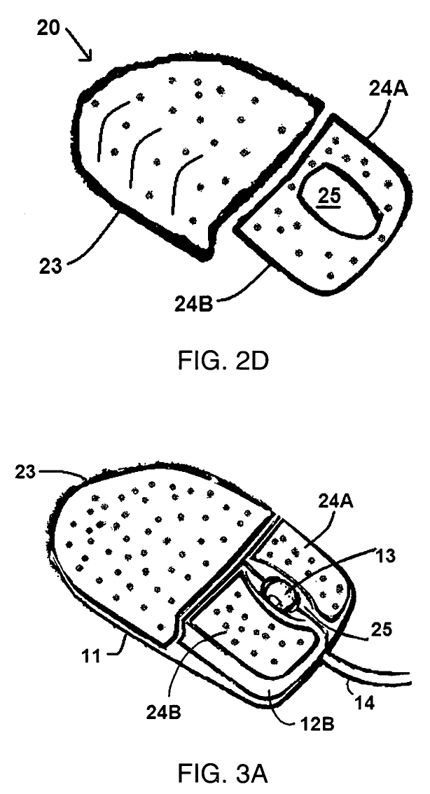

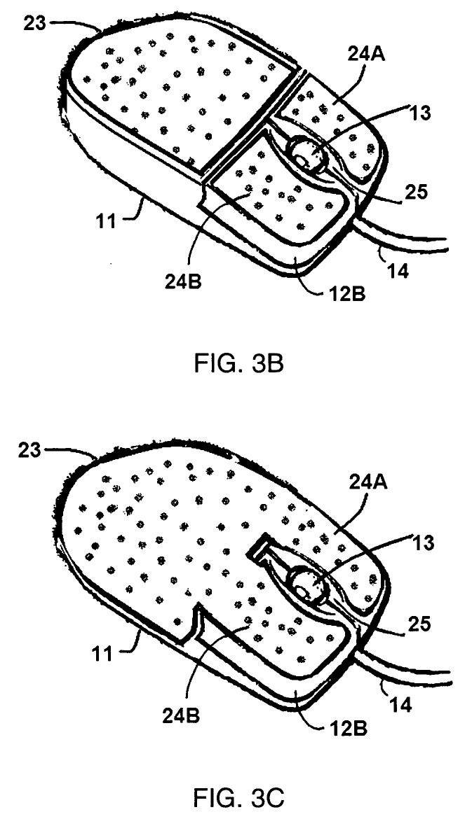

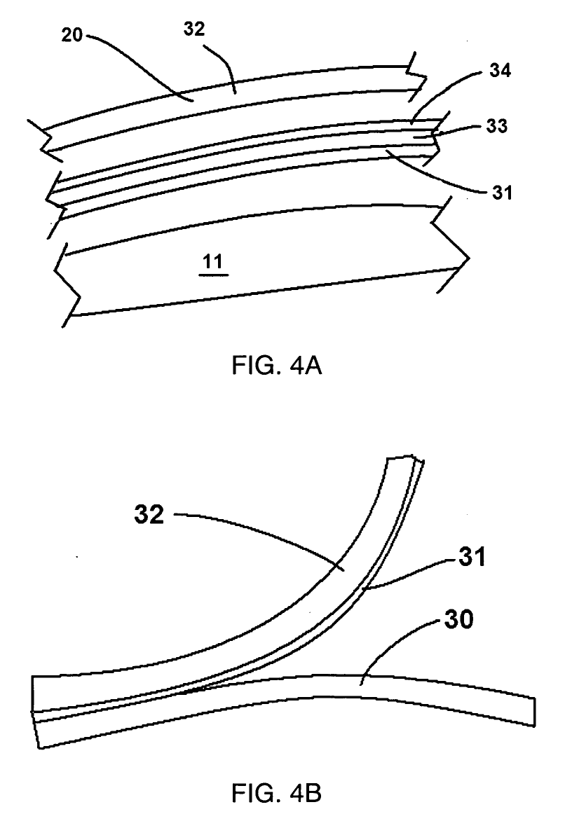

FIG. 1 is a view of a typical computer mouse illustrating the now conventional placement of the main body 11, mouse buttons 12 and thumbwheel actuator 13. FIG. 2A is an illustration of exemplary components of a first exemplary embodiment of the present invention showing a three-part design. FIG. 2B is an illustration of exemplary components of a second exemplary embodiment of the present invention showing a first one-part design. FIG. 2C is an illustration of exemplary components of a third exemplary embodiment of the present invention showing a second one-part design. FIG. 2D is an illustration of exemplary components of a fourth exemplary embodiment of the present invention showing a two-part design. FIG. 3A is an illustration of an exemplary embodiment of the present invention as shown in FIG. 2A in an exemplary environment. FIG. 3B is an illustration of an alternative exemplary embodiment of the present invention without sides in an exemplary environment. FIG. 3C is an illustration of an exemplary embodiment of the present invention as shown in FIG. 2B in an exemplary environment. FIG. 4A is an illustration of an exemplary adhesive device for attaching the present invention to a mouse comprising a permanent adhesive on one side of a substratum and a temporary adhesive on the other. FIG. 4B is an illustration of an alternative exemplary adhesive device for attaching the present invention to a mouse comprising a removable liner covering a pressure-sensitive adhesive on the underside of a piece of material of the mouse cover.

FIG. 1 is a view of a typical computer mouse 1 having a main body 11, sometimes called a hand rest section, a left mouse button 12A, a right mouse button 12, and a thumbwheel actuator 13. Also shown is a cable 14 for connecting the mouse to a computer (not shown). Cable 14 is not present in a wireless mouse. The common mouse housing is constructed of plastics or other polymers and rubbers or silicones. The electronic workings of the mouse 1 are contained within the housing and are actuated by the mouse buttons 12A, 12B and thumbwheel actuator 13.

FIG. 2 are illustrations of exemplary components of exemplary embodiments of the mouse cover 20 of the present invention. For example purposes only, the mouse cover 20 will be disclosed herein for use in combination with a typical mouse available in the year 2006, namely, a mouse having the above mentioned main body 11, left mouse button 12A, right mouse button 12, and thumbwheel actuator 13. However, the mouse cover 20 can be designed for alternative mouses 1, including future developed mouses 1, with simple design changes by those of ordinary skill in the relevant art field. For example, some mouses 1 have three or more mouse buttons 12, some mouses 1 do not have a thumbwheel actuator 13, and some mouses 1 have a thumbwheel actuator 13 that also pivots from side to side.

For the preferred embodiments of the invention, the mouse cover 20 preferably has a first button section 24A for covering the left mouse button 12A, a second button section 24B for covering the right mouse button 12B, and a third body section 23 for covering the main body 11. The button sections 24 are preferably shaped, or sized, or have a cutout portion, so as to provide a space 25 for the thumbwheel actuator 13. Although only button sections 24A and 24B are shown as providing the space 25, the body section 23 could also be shaped, or a portion cut out, to provide or assist in providing the space 25 if the configuration of the mouse 1 so required. As disclosed below, the various components or elements 23, 24 of the mouse cover 20 are sized and shaped so as to cooperate with the various components or elements of the mouse 1.

FIG. 2A is an illustration of exemplary components of a first exemplary embodiment of the present invention showing a three-part design. In this embodiment, body section 23, first button section 24A and second button section 24B are separate components that can be attached separately to the mouse 1. Also in this embodiment, body section 23, first button section 24A and second button section 24B are sized and shaped specifically to fit body 11, left mouse button 12A and right mouse button 12B, respectively. This can allow the mouse cover 20 to be attached to mouses 11 of various different sizes and shapes. Further in this embodiment, each of the sections 23, 24 can be removed and replaced as necessary and desired, including with different patterns and/or materials from each other.

FIG. 2B is an illustration of exemplary components of a second exemplary embodiment of the present invention showing a first one-part design. In this embodiment, body section 23, first button section 24A and second button section 24B are a single component that can be attached jointly to the mouse 1. As can be seen, there is a split or gap between first button section 24A and second button section 24B allowing for the more independent movement of first button section 24A relative to second button section 24B and vice versa. Also in this embodiment, body section 23, first button section 24A and second button section 24B are sized and shaped specifically to fit a specific or common body 11, left mouse button 12A and right mouse button 12B, combination. This can allow the mouse cover 20 to be attached to mouses 11 of a more or less common or single size and shape, and can require various different versions of the mouse cover 20 to fit various different mouses 1. Further in this embodiment, each of the sections 23, 24 generally cannot be separately removed and replaced.

FIG. 2C is an illustration of exemplary components of a third exemplary embodiment of the present invention showing a second one-part design. In this embodiment, body section 23, first button section 24A and second button section 24B also are a single component that can be attached jointly to the mouse 1. As can be seen, there is no split or gap between first button section 24A and second button section 24B allowing for somewhat less independent movement of first button section 24A relative to second button section 24B and vice versa. Also in this embodiment, body section 23, first button section 24A and second button section 24B are sized and shaped specifically to fit a specific or common body 11, left mouse button 12A and right mouse button 12B, combination. This can allow the mouse cover 20 to be attached to mouses 11 of a more or less common or single size and shape, and can require various different versions of the mouse cover 20 to fit various different mouses 1. Further in this embodiment, each of the sections 23, 24 also generally cannot be separately removed and replaced.

FIG. 2D is an illustration of exemplary components of a fourth exemplary embodiment of the present invention showing a two-part design. In this embodiment, body section 23 is first component and the combination of first button section 24A and second button section 24B are a second separate component, each of which can be attached separately to the mouse 1. Also in this embodiment, body section 23 and the combination of first button section 24A and second button section 24B are sized and shaped specifically to fit body 11, and the paring of left mouse button 12A and right mouse button 12B, respectively. This can allow the mouse cover 20 to be attached to mouses 11 of various different sizes and shapes. Further in this embodiment, each of body section 23 and the combination of first button section 24A and second button section 24B can be removed and replaced as necessary and desired, including with different patterns and/or materials from each other.

FIG. 3 are illustrations of exemplary embodiments of the mouse cover 20 attached to a mouse 1. In FIG. 3A, the mouse cover 20 of FIG. 2A is shown, in FIG. 3B an alternative mouse cover 20 is shown, and in FIG. 3C, the mouse cover 20 of FIG. 2B is shown. However, is will be apparent that the mouse covers 20 of FIGS. 2B, 2C, and 2D also can be and are attached to the mouse 1 in much the same manner and, for convenience, the disclosure of how the mouse cover 20 is attached to the mouse 1 will be explained in the following two exemplary embodiments. For both embodiments, and for the preferred embodiments, the mouse cover 20 covers the majority of the user surfaces of the mouse 1. As can be seen, the body section 23 fits on or over a major portion of at least the upper surface main body 11 of the mouse 1 and the button sections 24 fit on or over a major portion of at least the upper surfaces of the mouse buttons 12. In both embodiments, the space 25 allows for the thumbwheel actuator 13 to protrude through, and thus be available for manipulation by the user. As the thumbwheel actuator 13 rotates, it is more difficult to provide a cover for the thumbwheel actuator 13.

FIG. 3A is an illustration of an exemplary embodiment of the present invention as shown in FIG. 2A in an exemplary environment, that is, as applied to the exemplary mouse 1 of FIG. 1. In this embodiment, the third section 23 preferably covers substantially the top and the sides of the main body 11, as shown, so as to provide a more or less complete cover. Additionally, in this embodiment, the sides of the third section 23 extends circumferentially about the generally horizontal sides of the main body 11 from proximal to the section of the mouse 1 where the mouse button 12A is located to the section of the mouse 1 where the mouse button 12B is located. This version is most suitable for people who use their entire hand to control the mouse, namely with the thumb along one side of the mouse 1 and the smallest finger along the other side of the mouse 1. This version also is more suitable for public mouses or mouses used by two or more people, as this version covers, and therefore protects, more of the mouse 1.

FIG. 3B is an alternative embodiment of the mouse cover in which the third section 23 covers substantially only the top of the main body 11 and does not cover the sides of the main body 11. In this embodiment, the third section 23 preferably covers substantially the top of the main body 11, as shown, so as to provide a more or less complete cover of only the upper surface of the main body 11. This version is most suitable for people who use only their palm to control the mouse, and don not use their thumb or their smallest finger along the sides of the mouse 1. Also, due to there being less material, this is a less costly version of the mouse cover to manufacture. This version also is more suitable for private mouses or mouses used by one person, as this version covers, and therefore protects, less of the mouse 1.

FIG. 3C is an illustration of an exemplary embodiment of the present invention as shown in FIG. 2B in an exemplary environment, that is, as applied to the exemplary mouse 1 of FIG. 1. This illustration is similar to that shown in FIG. 3A, but includes the embodiment of the mouse cover shown in FIG. 2b for comparison purposes.

In still another alternative embodiment, the top and sides of the main body 11 are covered, including those portions of the sides of the main body 11 which extend under the mouse buttons 12A, 12B. Also as shown in FIG. 3, the first and second sections 24A, 24B substantially cover the mouse buttons 12A, 12B, respectively. Preferably, the sections 24 substantially cover only the top part of the mouse buttons 12. However, in an alternative embodiment, the sections 24 also cover at least part of the sides of the mouse buttons 12. In an alternative, there can be separate portions of the mouse cover 20 to cover the sides of the mouse 1. In yet another alternative embodiment, the sections 24 can be generally finger pad shaped and cover only a smaller portion of the mouse buttons 12.

In alternative embodiments wherein at least part of the sides of the mouse buttons 12 are covered and/or wherein at least part of at least one of the sides of the main body 11 that extends under the mouse buttons 12 is covered, then care should be taken that the mouse cover 20 does not interfere with the operation of the mouse 1. In addition, if a wireless mouse (not shown) is used, care should be used so as not to cover the infrared emitter (not shown) used by the mouse for communication with the computer. In an alternative embodiment, the part of the mouse cover 20 that covers the emitter is substantially transparent to infrared signals, and may be a different material than the other parts of the mouse cover 20, or even a hole cut through the mouse cover 20 at a strategic location.

The mouse cover 20 may be made of any desired material and preferably one that is not uncomfortable to the touch, and that does not cause the covered mouse 1 to slip out of the user's hand, or cause the user's fingers to slip on the covered mouse 1 buttons 12. For example, the mouse cover 20 may be made from natural or synthetic fabric, such as cloth, hide, film, fur or leather, may be woven or non-woven, may be smooth, furry, rough, textured, stippled, etcetera. In addition, the cover may be made in any desired color, combinations of colors, and pattern or combinations of patterns. Further, the mouse cover 20 can comprise random or picturesque patterns, scenes or photos, licensed logos such as sports team or corporate logos, and/or the like.

The provision of a surface for the mouse 1 other than a smooth plastic surface enhances the functionality of the mouse 1 by improving the tactile relationship and feedback between the mouse 1 and the hand of the user. Also, the provision of a surface for the mouse 1 other than a smooth plastic surface makes the mouse 1 easier to hold and thereby reduces user fatigue and errors. Additionally, changing the appearance (color, pattern, picture, and etcetera) of the mouse cover 20 is pleasant, aesthetically pleasing, enhances the user's experience, and contributes to a better attitude and more productivity on the part of the user.

FIG. 4A is an illustration of an exemplary adhesive device for use in connection with attaching the mouse cover 20 to the mouse 1. The adhesive device is two sided with a permanent adhesive 34 on one side of a substratum 33 and a temporary adhesive 31 on the other side of the substratum 33. The mouse cover 20 can be pre-laminated with the permanent adhesive 34 to the one side of the substratum 33. The combination of the mouse cover 20 and the adhesive device then can be attached to the mouse 11 using the temporary adhesive 31 side. A removable liner (not shown in FIG. 4A, but equivalent to removable liner 30 shown in FIG. 4B) can cover the temporary adhesive 31 prior to use.

FIG. 4B is an illustration of an alternative exemplary adhesive device for use in connection with attaching the mouse cover 20 to the mouse 1. The adhesive device comprises a removable liner 30 covering a pressure-sensitive adhesive 31 on the underside of a piece of material 30 of the mouse cover 20. The sections 23, 24 of the mouse cover 20 are preferably releasably bound to the mouse 1 by the adhesive 31 so that the sections 23, 24 can be easily removed at any time and do not permanently alter the original surface or appearance of the mouse 1. The adhesive 31 preferably binds the mouse cover 20 and the mouse 1 tightly enough to prevent the mouse cover 20 from moving or detaching in normal use, but also preferably binds them loosely enough that, if desired, the mouse cover 20, or the sections 23,2 4 thereof, may be removed from the mouse 1. Preferably, the adhesive 31 binds better to the mouse cover 20 so that, when the mouse cover 20 is removed, bits of adhesive 31 are not left on the mouse 1. The adhesive 31 is preferably initially covered by the removable liner 30 and the removable liner 30 is removed to expose the adhesive 31 when the mouse cover 20 is to be applied to the mouse 1. Preferably, but not necessarily, the adhesive i31 s a pressure-sensitive adhesive.

Users often operate a mouse 1 while eating and/or drinking, and the mouse cover 20, depending upon the fabric, may absorb food or liquid, including sweat, and thereby become unsanitary and a breeding or holding ground for undesired organisms such as bacteria, viruses, mold, etcetera. Therefore, the mouse cover 20, or at least some sections 23, 24 of the mouse cover 20, is occasionally or even periodically replaced with a new mouse cover 20 or sections 23, 24 so as to provide a new and desirable appearance for the mouse 1 and/or to remove undesired organisms. To facilitate this, the use of the embodiment shown in FIG. 2A and a temporary adhesive 31 can be preferred.

In an alternative embodiment, the mouse cover 20 can be treated with at least one antibacterial or other product, such as a disinfectant, so as to at least retard the growth of undesired organisms. The treatment should, of course, typically not cause health or other problems when the mouse cover 20 is held by or in the human hand. For example, the treatment should not result in the human hand coming into contact with, or being exposed to, excessively acidic, caustic, or toxic substances, substances which are likely to cause allergic or severe allergic reactions in a number of users, and etcetera.

Although the present invention has been shown in use with a two-button mouse having a thumbwheel, the present invention is not so limited and may be used with a mouse which does not have a thumbwheel actuator, with a single-button mouse, with a mouse having more than two mouse buttons, with a wired mouse or a wireless mouse, etcetera. Further, the invention can be altered to be usable with a trackball or other computer input device by those of ordinary skill in the computer accessory art without undue experimentation.

The present invention therefore provides a cover for a computer mouse. Although various embodiments of the present invention have been described in detail herein, other variations may occur to those reading this disclosure without departing from the spirit of the present invention. Accordingly, the scope of the present invention is to be limited only by the claims.

### LIST OF REFERENCE NUMERALS

Number Name

1 Computer mouse
11 Main body or hand rest of mouse
12A Left mouse button
12B Right mouse button
13 Thumbwheel actuator of mouse
14 Cable for mouse
20 Mouse cover
23 Third section for covering main body 11 of mouse
24A First section for covering left mouse button 12A
24B Second section for covering right mouse button 12B
25 Space or hole for thumbwheel actuator 13
30 Removable liner
31 Temporary adhesive
32 Material of the cover
33 Substratum
34 Permanent adhesive

What is claimed is:

1. A cover for a computer mouse, the computer mouse having a main body, a first mouse button, and a second mouse button, the cover comprising:
a first section for covering at least a portion of the first mouse button;
a second section for covering at least a portion of the second mouse button; and
a third section for covering at least a portion of the main body.

2. The cover of claim 1 further comprising an adhesive, wherein the first section is adhered to the first mouse button by the adhesive, the second section is adhered to the second mouse button by the adhesive, and the third section is adhered to the main body by the adhesive.

3. The cover of claim 1, wherein the computer mouse also has a thumbwheel actuator, and wherein one of the first section or the second section has a cutout portion to expose the thumbwheel actuator.

4. The cover of claim 1, wherein the computer mouse also has a thumbwheel actuator, and wherein each of the first section and the second section has a cutout portion to expose the thumbwheel actuator.

5. The cover of claim 1 wherein at least one of the first section, the second section, or the main body is treated with at least one antibacterial product.

6. The cover of claim 1 wherein at least one of the first section, the second section, or the third section further comprises a removable liner which covers the adhesive until the selected first section, second section, or third section is to be applied to the computer mouse.

7. The cover of claim 1 wherein at least one of the first section, the second section, or the third section comprises a material selected from the group consisting of natural or synthetic fabrics, hide, film, fur, leather, and woven and non-woven materials.

8. The cover of claim 1 wherein at least one of the first section, the second section, or the third section comprises a material covered by an adhesive protected by a removable liner.

9. The cover of claim 1, having a three-part design, wherein the first section, the second section, and the third section are separate components that is attached separately to the computer mouse.

10. The cover of claim 9, wherein the first section the second section and the third section are sized and shaped specifically to fit the first mouse button, the second mouse button and the main body, respectively.

11. The cover of claim 1, having a one-part design, wherein the first section, the second section, and the third section are a single component that is attached jointly to the mouse.

12. The cover of claim 11, wherein the single component is sized and shaped specifically to fit the mouse.

13. The cover of claim 1, having a two-part design, wherein the third section is a first component and a combination of the first section and the second section are a second component, each of which is attached separately to the mouse.

14. The cover of claim 13, wherein the third section and the combination of first section and the second section are sized and shaped specifically to fit the main body of the mouse and the paring of the first mouse button and the second mouse button, respectively.

15. A cover for a computer mouse, the computer mouse having a main body, a first mouse button, and a second mouse button, the cover comprising:
a first section for covering at least a portion of the first mouse button;
a second section for covering at least a portion of the second mouse button;
a third section for covering at least a portion of the main body; and
an adhesive,
wherein the first section is adhered to the first mouse button by the adhesive, the second section is adhered to the second mouse button by the adhesive, and the third section is adhered to the main body by the adhesive.

16. The cover of claim 15, wherein the first section has a cutout portion to expose the thumbwheel actuator, the second section has a cutout portion to expose the thumbwheel actuator.

17. The cover of claim 15, wherein at least one of the first section, the second section, or the main body is treated with at least one antibacterial product.

18. The cover of claim 15 wherein at least one of the first section, the second section, or the main body comprises a material selected from the group consisting of natural or synthetic fabrics, hide, film, fur, leather, and woven and non-woven materials.

19. The cover of claim 15, having a three-part design, wherein the first section, the second section, and the third section are separate components that is attached separately to the computer mouse.

20. The cover of claim 19, wherein the first section the second section and the third section are sized and shaped specifically to fit the first mouse button, the second mouse button and the main body, respectively.

21. The cover of claim 15, having a one-part design, wherein the first section, the second section, and the third section are a single component that is attached jointly to the mouse.

22. The cover of claim 21, wherein the single component is sized and shaped specifically to fit the mouse.

23. The cover of claim 15, having a two-part design, wherein the third section is a first component and a combination of the first section and the second section are a second component, each of which is attached separately to the mouse.

24. The cover of claim 23, wherein the third section and the combination of first section and the second section are sized and shaped specifically to fit the main body of the mouse and the paring of the first mouse button and the second mouse button, respectively.
